(19) United States
(12) Patent Application Publication
(10) Pub. No.: US 2004/0258861 A1
(43) Pub. Date: Dec. 23, 2004

(54) Preform and thin wall container

(76) Inventor: Takekazu Mochizuki, Nagano (JP)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/834,570

(22) Filed: Apr. 29, 2004

(30) Foreign Application Priority Data
Apr. 30, 2003 (JP) 2003-125823

(51) Int. Cl. F16L 1/00

(52) U.S. Cl. 428/34.1

(57) ABSTRACT

The purpose of the present invention is to prevent a falling out of a neck portion of a preform without a protrusion such as screw or support ring from a neck mold of a preform. The present invention relates to a preform comprising an open end edge formed as a flange overhanging outwardly, a circular neck portion formed under said open end edge by a neck mold for an outer side of said neck portion and an injection core for an inner side of said neck portion, and closed bottom portion, wherein; an outer peripheral surface of said circular neck portion is formed by the neck mold to a chamfered form having a thin wall portion and a thick wall portion alternately arranged at regular intervals, and a lower end edge of said thin wall portion is formed as an engagement portion with the neck mold.

### BACKGROUND OF THE INVENTION

1. Field of the Invention

The present invention relates to a preform in order to produce a thin wall container without a protrusion such as a screw or a support ring and the like around a neck portion and also relates to a packaging container made from the preform by stretch blow molding.

2. Prior Art

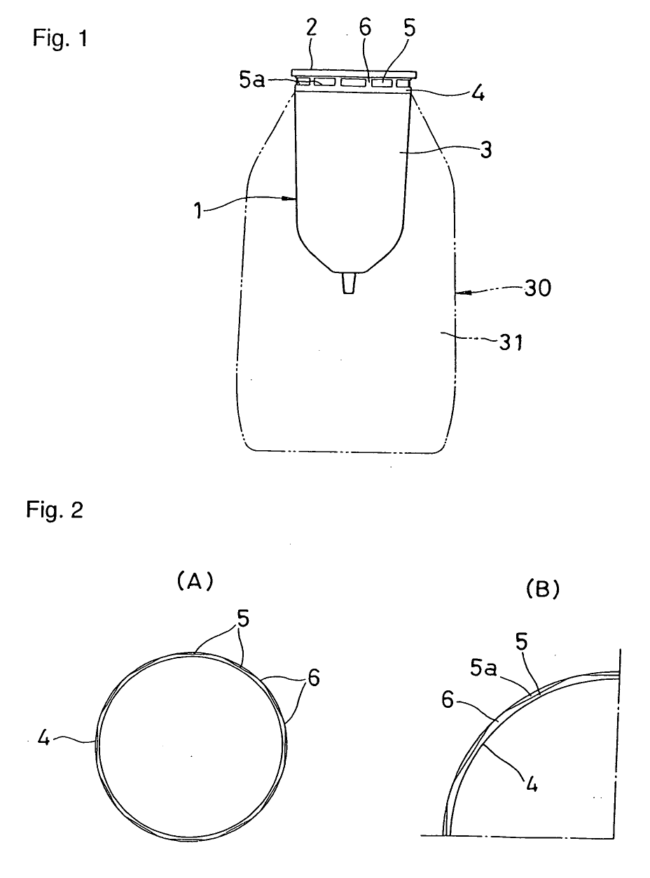

According to the conventional preform of a cup like container, a tiny protrusion is formed on the side surface under the flange of the open end edge and a falling out of the preform from a neck mold is prevented by the protrusion, while the preform is pulled out from an injection core (reference patent 1: Japanese Utility Model Publication 4-20012, Pages 1-2, FIGS. 1 to 3).

A protrusion such as a screw or a support ring and the like on the outer side surface of a neck portion is formed by a neck mold as a preform for a packaging container which is formed to a thin wall other than the neck portion by the stretch blow molding and a bottle and the like which requires a cap to seal tightly, and the neck portion of the preform is formed by the neck mold for the outer side and an injection core for the inner side. Since the preform is in the state of being caught with the protrusion in the neck mold after the injection molding, while the injection core is being pulled out from the preform, the neck mold works as a holding mold to prevent from falling out of the neck mold with the injection core. Therefore, the prevention of the falling out of the preform is not necessary to be considered particularly.

However, as for a preform for a thin wall container molded by stretch blow molding for a packaging container which has a open end edge with a flange, being sealed by adhering with aluminum seal and the like, for example containers widely used for food application such as a lactic acid drink or foods having viscous property has no protrusion other than the flange of the open end edge formed between the neck mold and a base portion of the injection core, and also, there is nothing on the preform to be held by the neck mold, and when the injection core is pulled out after the injection molding, a phenomena presents that the preform is fallen out from the neck mold while adhering to the injection core.

According to the conventional technology described in the reference patent 1, as the prevention measure for the falling out, on the side surface under the flange of the open end edge of the preform, a tiny protrusion which engages the preform with a holding mold (neck mold) is formed between the holding mold and an injection mold, and the protrusion is eliminated during the expansion of the preform while being stretch blow molded into a cup. However, although the prevention measure is effective for the case of molding a cup like container by stretch blow molding a preform of which the wall is formed thick from the bottom portion to under the flange of the open end edge according to the reference patent 1, the protrusion becomes solid state in the normal molding which a mold release of the preform is conducted after the neck portion becomes the solid state because the position of the protrusion is between the neck portion and the stretch portion, and even a tiny protrusion, it is difficult to be eliminated completely by expansion at blow molding. A part of the protrusion left on the outer surface of the container causes to be a defective product, so that it is a problem that the above mentioned prevention measure can not be adopted for molding a thin wall container of making the mold release after the neck portion becomes a complete solid state.

### SUMMARY OF THE INVENTION

The present invention is devised to solve the above mentioned problem of the conventional technology, and its purpose is to provide a new preform and a thin wall container by using a preform, comprising a neck portion having a thin wall portion and a thick wall portion which can be as the neck portion of the thin wall container without modification, thus both thinning the neck portion of the preform by the thin wall portion and keeping the strength by the thick wall portion can be accomplished, and also, the preform being prevented from falling out from the neck mold.

The present invention relates to a preform comprising,

an open end edge formed as a flange overhanging outwardly, a circular neck portion formed under said open end edge by a neck mold for an outer side of said neck portion and an injection core for an inner side of said neck portion, and closed bottom portion, wherein;

an outer peripheral surface of said circular neck portion is formed by the neck mold to a chamfered form having a thin wall portion and a thick wall portion alternately arranged at regular intervals, and a lower end edge of said thin wall portion is formed as an engagement portion with the neck mold.

A thin wall container according to the present invention has a thin wall body formed by stretch blow molding the lower portion from the lower end edge of the thin wall portion of the neck portion of the above mentioned preform.

### BRIEF DESCRIPTION OF THE INVENTION

FIG. 1 is a side view of a preform (solid line) and a thin wall container (chain line) according to one embodiment of the present invention.

FIG. 2 is an A-A sectional view as figure (A) and the enlarged view as figure (B) of FIG. 1.

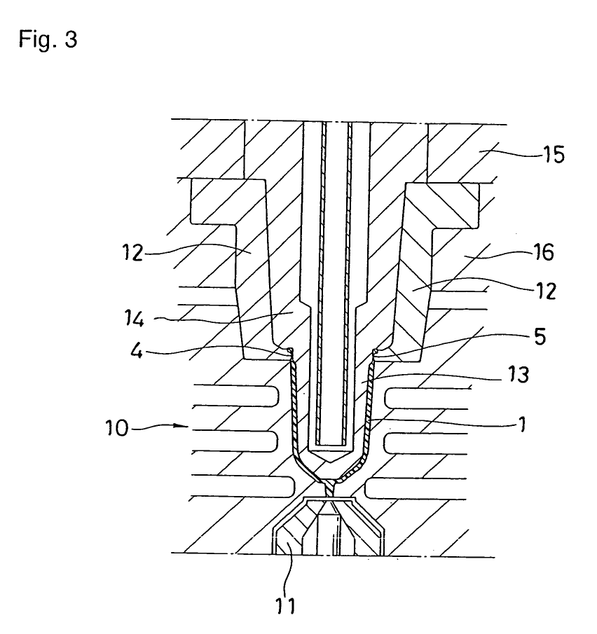

FIG. 3 is a longitudinal sectional view of an injection mold, a neck mold, and an injection core in the molding state of the preform.

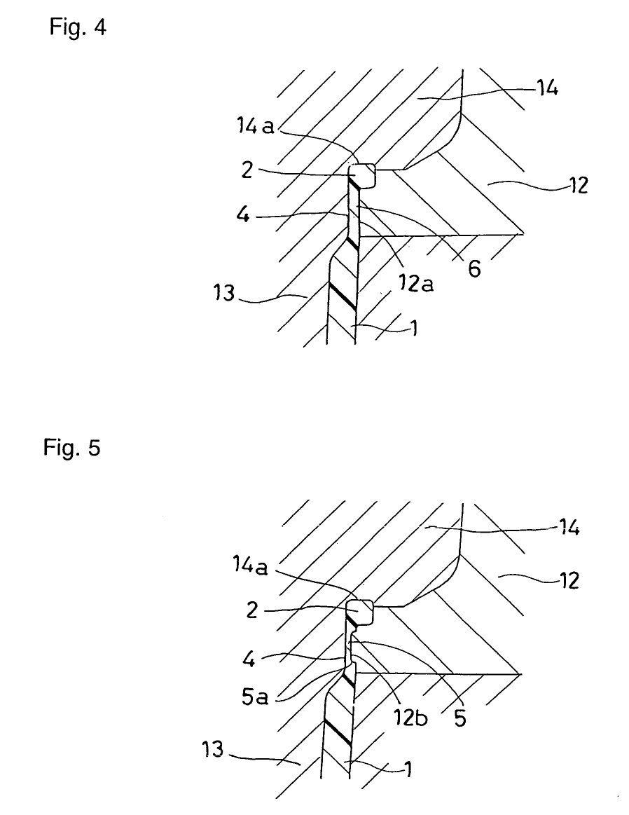

FIG. 4 is a sectional view of a thick portion of a neck mold and a neck portion.

FIG. 5 is a sectional view of the thin portion of the neck mold and the neck portion.

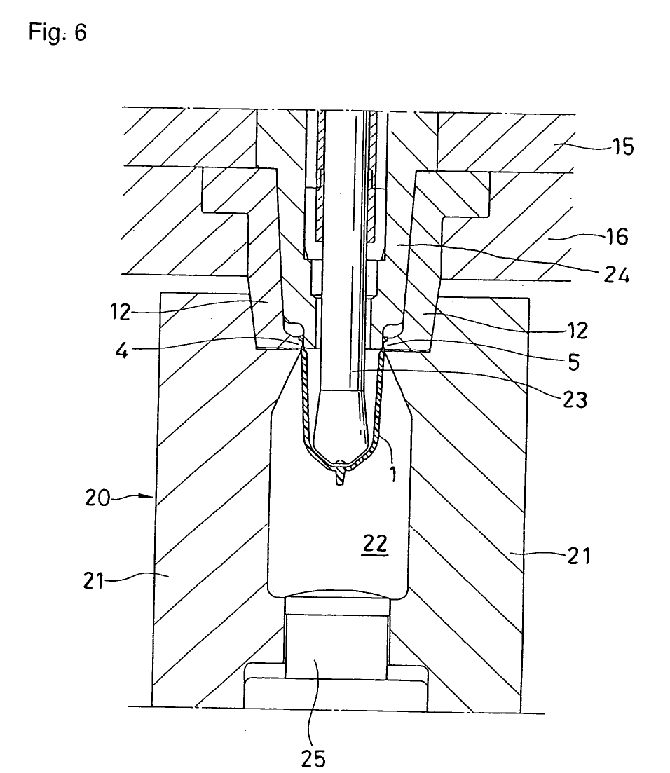

FIG. 6 is a longitudinal sectional view of the neck mold, a stretch rod and the preform in the state of mold closing of a blow mold.

### DETAILED DESCRIPTION OF THE INVENTION

In the above mentioned structure of the preform of the present invention, since the neck portion and the neck mold are tightly engaged by the lower end edge of the thin wall portion formed by chamfering at regular intervals in the outer peripheral surface of the neck portion, even though the neck portion is stuck to the injection core, the preform is separated from the injection core by the force of pulling out the core, so that the preform is left in the neck mold, and falling out of the preform from the neck mold while pulling out the injection core is eliminated.

Also, the neck portion comprises the thin wall portion and the thick wall portion having the thickness gradually increase and decrease alternately created by chamfering the outer peripheral surface of the neck portion. Even if the thin wall portion is formed at regular intervals, since the thickness of the thin wall portion gradually increases toward the thick wall portion, a flow resistance of resin through the thick wall portion during the injection molding is small, and no weld is created in the neck portion caused by the thin wall portion.

Also, since the neck portion is formed as the neck portion of container at molding a preform, sometimes the thickness of the neck portion is formed thinner wall than usual case depending on containers. In such case, the thin wall portion by chamfering can be formed, and even the gaps of the lower end edges of the thin wall portion are small, the gaps positioned at regular intervals in the outer peripheral surface can hold engagement of the neck portion with the neck mold, and falling out from the neck mold of the preform while pulling out of the injection core can be prevented without a limitation of the neck portion thickness.

Moreover, as for the stretch blow molding of hot parison method, a release of the preform from the mold is conducted in the early stage while in high temperature, but the release is done after the neck portion being cooled to the solid state. In the preform of the above mentioned constitution, since the thin wall portion accelerates the neck portion to be solid with cooling by the neck mold, the time required to for injection molding a preform is shortened, and the release of the preform from the mold can be conducted earlier, so that it contributes to reduce the molding cycle time.

Also, as for the container of the above mentioned constitution, the neck portion is partially thin by the thin wall portion, but as the thin wall portion is reinforced by the thick wall portion arranged at regular intervals, the deformation of the open end edge is prevented because the neck portion resists to the tensile or holding force applied to the open end edge at the stage of filling the contents or of delivery, and since the neck portion supports the open end edge while making closure by an adhesion of covering member such as aluminum sheet and the like, sealing with the covering member can be easily conducted.

In FIG. 1 and FIG. 2, a reference numeral 1 is a closed end preform made by injection molding comprising a circular neck portion 4 integrally, continuing into a cylindrical body portion 3 under an open end edge 2 having an outwardly overhanging flange. The outer peripheral surface of the neck portion 4 is chamfered at regular intervals of 30 degree so as to leave a thick wall portion 6 with the thickness (e.g.: 0.25 mm). Thus, the neck portion 4 constitutes of a thin wall portion 5 and the thick wall portion 6 which have alternately increase and decrease of the thickness gradually, and at least a lower edge 5a of the thin wall portion 5 is used as the engagement portion with the neck mold, which is described below.

A numeral reference 30 is a container having a thin wall body portion 31 formed by stretch blow molding the preform 1, and the open end edge and neck portion comprises the same structure with the preform 1.

In FIGS. 3, 4 and 5, a reference numeral 10 is an injection mold to form an outer surface of a body portion 3 and a bottom portion of the preform 1, and an injection nozzle 11 is in nozzle touch state to a cavity gate of the bottom portion of the mold. A reference numeral 12 is the neck mold serving both a holding mold and forming the neck portion 4 of the preform 1 and comprises a pair of short cylindrical split cavity molds which are able to form the neck forming portion of circular hole in the inside of the lower end, and the neck mold 12 is provided under a transport platen 15 fixed with a holding plate 16, movable for opening and closing to mate the split mold.

The neck forming portion of the above mentioned neck mold 12 comprises a concave surface 12a which forms the thick wall portion 6 arranged at regular intervals of 30 degree on the neck portion 4 of the preform 1 by chamfering the inner peripheral surface of a circular hole and a convex surface 12b which forms the thin wall portion 5 between the thick wall portions 6 alternately and continuously, and by the concave surface 12a and the convex surface 12b, the outer peripheral surface of the neck portion 4 is able to be chamfered at regular intervals.

A reference numeral 13 is an injection core forming the inside of the preform 1, and it is integrally formed with a core body 14 inserted from upward into the neck mold 12. An open end edge 2 of the preform 1 is formed between the gap around the injection core, formed between the core 13 and the core body 14, and the neck forming portion of the neck mold 12.

In FIG. 6, a reference numeral 20 is a blow mold which forms a blow cavity 22 by a closed state of a pair of split molds 21 movable for opening and closing. A reference numeral 23 is a stretch rod, and it is inserted to the center of a blow core 24. A reference numeral 25 is a vertically movable bottom mold for the bottom portion of the blow cavity 22.

After the above mentioned preform 1 is formed by injecting molten resin into a cavity (figure omitted) which is formed by the combination of an injection mold 1, an injection core13, and a neck mold12, the preform1 is released from an injection mold 10 by the upward movement of the neck mold 12, and also the injection core 13 is pulled out by the upward movement of the core body 14. On this occasion, the neck portion 4 sticks firmly to the injection core 13 inside by a shrinkage caused by cooling the resin, but as shown in FIG. 5, the convex surface 12b of the neck mold 12 is in the fitting state with the neck portion 4, and the neck mold 12 is engaged to the lower end of a thin wall portion 5 at regular intervals on the outer peripheral surface of the neck portion 4, so the preform 1 and the injection core 13 are separated by a force of pulling out the injection core 13, and the preform 1 is prevented from falling out with the injection core 13.

The preform 1 which is released from the above mentioned injection mold 10 and the injection core 13 and continuously held by the neck mold 12 is transferred to the blow mold 20 in the state of mold opening with the neck mold 12 by a transfer palten15. Even in the case of this transfer, the convex surface 12b of the neck mold 12 is in the fitting state with the outer peripheral surface of the neck portion 4, and the lower edge 5a of the thin wall portion 5 of the neck portion 4 and the neck mold 12 are connected, so that the preform 1 is prevented from falling out from the neck mold 12 by the inertia in the beginning of the transfer or stopping.

After the transfer, the preform1, as shown in FIG. 6, is positioned at the center of the blow cavity 22 by closing the blow mold 20, accordingly the upper portion of the blow cavity and the neck mold 12 are closed, and moreover the blow core 24 is fitted to the neck mold 12 from upward, and a stretch rod 23 is inserted and positioned to the inside of the preform.

Subsequently, lower portion of the preform1, from the lower end edge of the thin wall portion of the neck portion 4 (figure omitted) is stretch blow molded, while being held in the neck mold12, by elongation of the stretch rod 23 and an air blow, and it is formed to be a thin wall container 30 comprising the open end edge 2 formed with a flange overhanging outwardly, the neck portion 4 which is formed under the open end edge 2 in circular form and which also comprises the thin wall portion 5 and the thick wall portion 6 having the thickness gradually increase and decrease alternately formed by chamfering on the outer peripheral surface of the neck portion having regular intervals, and a body portion 31, equally with a shoulder portion and a bottom portion which are formed to thin wall.

What is claimed is:

1. A preform comprising,
an open end edge formed as a flange overhanging outwardly, a circular neck portion formed under said open end edge by a neck mold for an outer side of said neck portion and an injection core for an inner side of said neck portion, and closed bottom portion, wherein;
an outer peripheral surface of said circular neck portion is formed by the neck mold to a chamfered form having a thin wall portion and a thick wall portion alternately arranged at regular intervals, and a lower end edge of said thin wall portion is formed as an engagement portion with the neck mold.

2. A thin wall container having a thin wall body formed by stretch blow molding the lower portion from the lower end edge of the thin wall portion of the neck portion of the preform according to claim 1.
